(19) United States
(12) Patent Application Publication
(10) Pub. No.: US 2017/0041291 A1
(43) Pub. Date: Feb. 9, 2017

(54) PORTABLE CYBER SECURITY DEVICE

(71) Applicants: Arial Zibziner, Alfai Menashe (IL); Menahem Zibziner, Alfei Menashe (IL)

(72) Inventors: Arial Zibziner, Alfai Menashe (IL); Menahem Zibziner, Alfei Menashe (IL)

(21) Appl. No.: 15/232,309

(22) Filed: Aug. 9, 2016

Related U.S. Application Data
(60) Provisional application No. 62/202,841, filed on Aug. 9, 2015.

(51) Int. Cl. H04L 29/06; H04W 12/08

(52) U.S. Cl. CPC H04L 63/0209; H04W 12/08; H04L 63/20

(57) ABSTRACT

A portable cyber security device that includes a virtual base station; a cyber security processor; and a cellular network module; wherein the virtual base station is configured to communicate with a mobile phone; wherein the cellular network module is configured to communicate with a base station of a cellular network; and wherein the cyber security processor is configured to apply a cyber security operation on content received by either one of the virtual base station and the cellular network module.

### RELATED APPLICATIONS

This patent claims the priority of U.S. patent application Ser. No. 62/202841 filing date Aug. 9, 2015, which is incorporated herein in its entirety.

### BACKGROUND

Cellular communication between one mobile phone to another (or cellular terminals) is not fully secured and can be tapped and intercepted in many ways. Moreover, there are known methods to hack the encrypted algorithms of some mobile communication standards, therefore the information and intellectual property we share in a cellular voice call, SMS or Data can be disclosed.

### SUMMARY

There may be provided a portable cyber security device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a mobile phone and a portable cyber security device according to an embodiment of the invention;

FIG. 2 illustrates a portable cyber security device, a base station and a mobile phone according to an embodiment of the invention;

FIG. 3 illustrates secured call connection between two mobile phones that are paired to portable cyber security devices according to an embodiment of the invention;

FIG. 4 illustrates a jacket that includes the portable cyber security device according to an embodiment of the invention;

FIG. 5 illustrates a handbag that includes the portable cyber security device according to an embodiment of the invention;

FIG. 6 illustrates a stand-alone portable cyber security device and multiple mobile phones according to an embodiment of the invention;

FIG. 7 illustrates a jacket that is detachably connected to the portable cyber security device according to an embodiment of the invention;

FIG. 8 illustrates a mobile phone and a portable cyber security device according to an embodiment of the invention;

FIG. 9 illustrates a mobile phone and a portable cyber security device according to an embodiment of the invention;

FIG. 10 illustrates a user equipment a base station and a portable cyber security device according to an embodiment of the invention;

### DETAILED DESCRIPTION OF THE DRAWINGS

In the following detailed description, numerous specific details are set forth in order to provide a thorough understanding of the invention. However, it may be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It may be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details may not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

The term “cellular network” may mean a radio network distributed over land through cells where each cell includes a fixed location transceiver known as base station. These cells together provide radio coverage over larger geographical areas. User equipment (UE), such as mobile phones, is therefore able to communicate even if the equipment is moving through cells during transmission.

The term “cyber security” may mean information technology security, protecting computers, networks, programs and data from unintended or unauthorized access, change or destruction.

The term “firewall” may mean a network security system that controls inbound and/or outbound network traffic based on a set of rules.

The term “portable cyber security device” is a device that is portable and is configured to perform one or more cyber security operations on communications between a user equipment and a base station. The communication may reach the base station directly or indirectly.

The term “virtual base station” may mean a communication module that is viewed by the mobile phone as a base station although the virtual base station is not necessarily part of the original infrastructure of the cellular network. A virtual base station may be configured to communicate with a single mobile phone or up to a certain number of mobile phones—the certain number is usually a small fraction of that numbers of mobile phones that may populate a cell of the cellular network.

The terms cellular and mobile are used in an interchangeable manner.

The specification refers to a mobile phone. A mobile phone is merely a non-limiting example of a device, module or apparatus that that is configured to communicate with elements (such as a base station) of a cellular network. This device, module or apparatus may be user equipment, may be a mobile or stationary, and the like.

The specification may refer to an attachment of the portable cyber security device to the mobile phone. An attachment is merely a non-limiting example of pairing between the portable cyber security device and the mobile phone. The pairing may be executed without attaching the portable cyber security device to the mobile phone. Pairing means that the portable cyber security device and the mobile phone communicate with each other. The pairing may include inducing the mobile device to register the portable cyber security device as its base station.

The portable cyber security device may be paired to a mobile phone and then perform, for communication to and from the mobile phone (inbound and outbound communication) perform voice packet encryption/decryption during mobile communication, specifically, securing the native voice and SMS communication in addition to the data communication channels.

The portable cyber security device may function as a firewall and may execute firewall operations.

The portable cyber security device may operate without making a change in the mobile phone and without changing the way of operation of the mobile phone.

One or more portable cyber security devices that are paired with multiple mobile phones may secure the connection between two mobile phones or cellular terminals with minimum disruption to a mobile phone user.

A user may use his mobile phone with a paired portable cyber security device) that may manage the secured connection and encryption\decryption of the voice and SMS traffic.

When the user activates a security communication mode (or when the security communication mode is activated regardless of the user) the communication between users can be prevented from being disclosed.

The portable cyber security device may be attached to a mobile phone to enable direct encrypted communication between two terminals of a cellular radio network of the GSM/DCS type, UMTS type and/or by satellite.

The portable cyber security device may communicate with the base station over the existing radio cellular network, there is no need for a physical connection between the portable cyber security device and the mobile phone.

The portable cyber security device may include a virtual base station in order to connect and acquire the mobile phone.

The portable cyber security device may provide dedicated cellular reception to the attached mobile phone (or phones).

The portable cyber security device, once attached to the mobile phone, may act as virtual base station of the cellular network. The portable cyber security device may then encrypt\decrypt the voice and SMS traffic of the cellular network and deliver it forward onto the Service provider's core network infrastructure.

The portable cyber security device may act as a mediation device between the mobile phone and the cellular network.

The independent firewall and additional cyber passive security modules on the portable cyber security device may secure the inbound and outbound connection to the mobile phone device.

On the recipient mobile phone there may be another portable cyber security device that may be used in the same way to encrypt\decrypt the voice and SMS traffic allowing point-to-point secured connection between two mobile phones or cellular terminals.

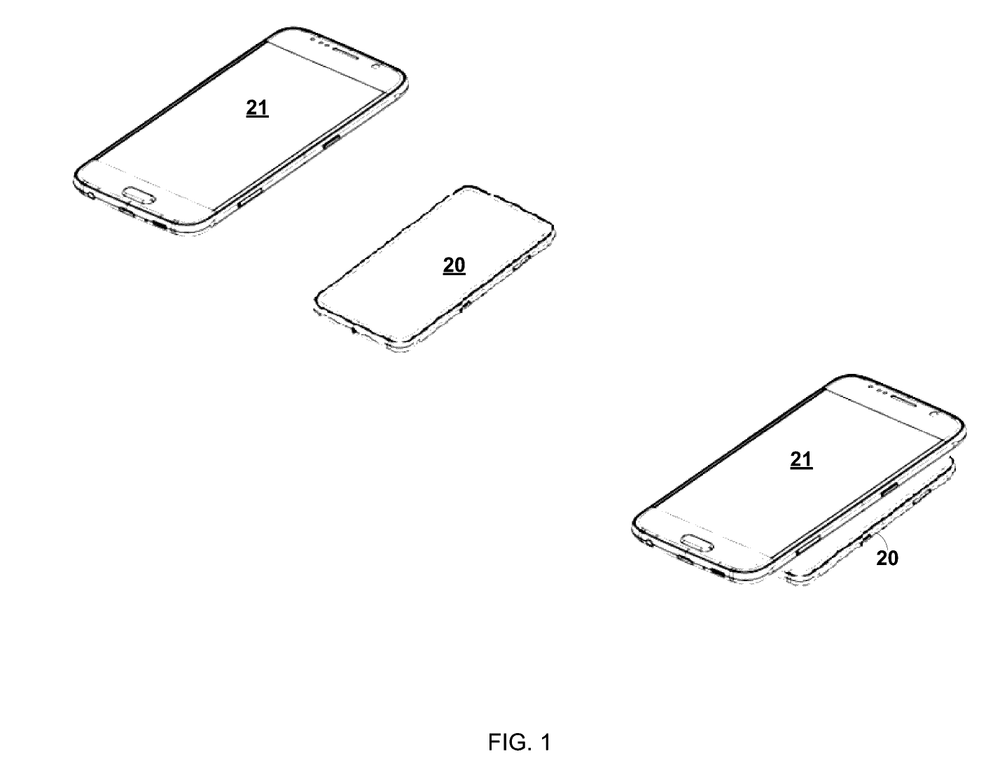

In order to establish secured connection between two mobile phones or cellular terminals, both mobile phones may need to attach the portable cyber security device to the mobile phone. The portable cyber security device may be physically attached to the mobile phone as shown in FIG. 1—that illustrates portable cyber security device 20 and the mobile phone 21 as being attached to each other and as being non-attached to each other.

The portable cyber security device that is attached to the mobile phone may act as a close-range virtual base station with signal strength to acquire only the attached mobile phone.

The portable cyber security device may induce the mobile phone to register the portable cyber security device as the base station by any technique. For example—when the mobile phone registers the strongest base station—the portable cyber security device may transmit stronger signals than the signals of other base stations. Accordingly—using the mobile network behavior, once the mobile phone recognizes the portable cyber security device as having with higher signal strength it may drop the previous base station and move to the higher signal—to the portable cyber security device.

The portable cyber security device virtual base station acquires the mobile phone, therefore, all radio traffic of the mobile phone is routed through the portable cyber security device.

The portable cyber security device may encrypt\decrypt the traffic using it's processing units and encrypted algorithm in addition to some encryption/decryption standards that may be applied by the cellular network provider. The portable cyber security device may then interface back to a cellular network using a cellular. The independent firewall and cyber security module on the portable cyber security device may secure the inbound and outbound traffic.

The operation described may be transparent the user with no need to manage any action besides attaching the portable cyber security device to the mobile phone. When the portable cyber security device is detached from the mobile phone, the mobile phone may go back automatically to it's associated mobile network provider by finding and acquiring the nearest cell base station.

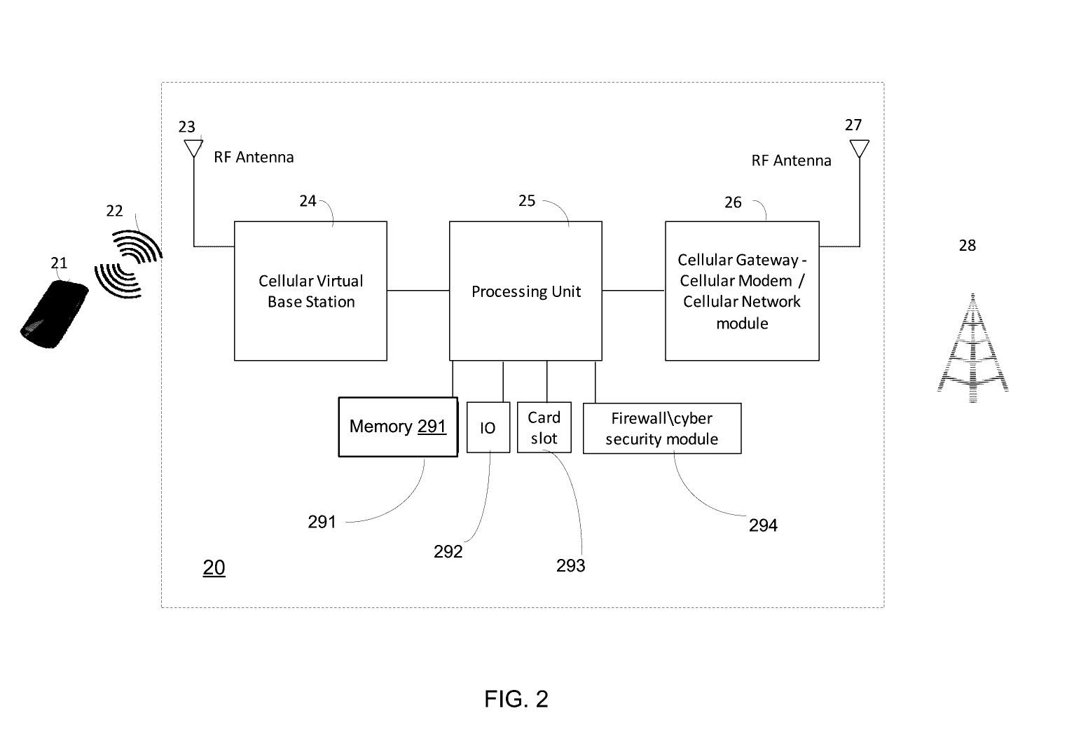

FIG. 2 illustrates a portable cyber security device, a base station and a mobile phone according to an embodiment of the invention.

The portable cyber security device acts as a mediation device between the mobile phone 21 and the cellular network 28.

Virtual base station module 24 is equipped with a cellular antenna 22

When the portable cyber security device is attached to the mobile phone, the virtual base station 24 transmit a close range strong signal of a legit base station causing the mobile phone to drop its existing cell base station and register with the virtual base station 24.

All cellular traffic of the mobile phone is then transmitted straight through the virtual base station. From the virtual base station, the cellular traffic is delivered to the processing unit (also referred to as cyber security processor) 25 that has a firewall and cyber security module. The processing unit 25 manages the two-way routing\processing and\or encryption\decryption of the traffic. From the processing unit 25 the traffic is delivered to cellular network module (also referred to as cellular gateway module and/or cellular network modem) that may be equipped with antenna 27 to manage the traffic connection to a service provider's cellular commercial network—represented by base station 28. When using a cellular modem there is a need for additional SIM card of any kind and the registration on to the commercial cellular network may be done using this additional SIM. This turn the mobile phone 21 original identity and SIM installed in it to be undisclosed during calls or SMS traffic. FIG. 2 illustrates that the portable cyber security device 20 may include a memory 291, input output module IO 292, card slot 293 and firewall/cyber security module 294.

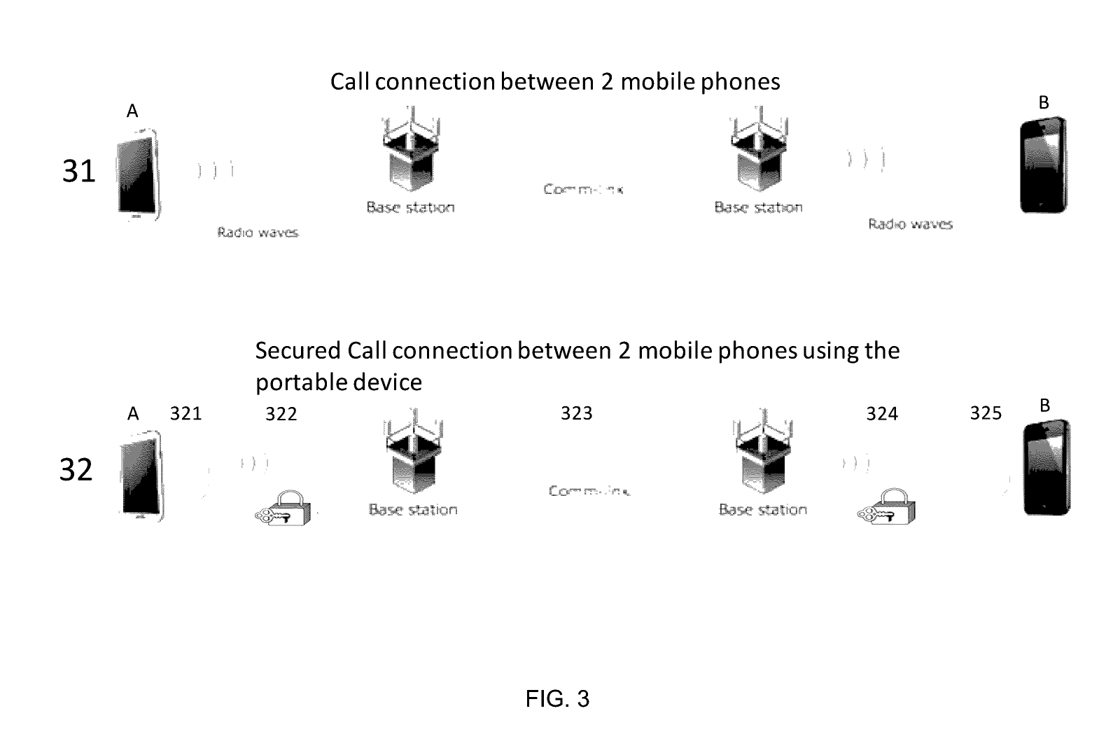

FIG. 3 describes the basic network connection between two mobile phones that are paired to portable cyber security devices 321 and 325 respectively.

In the upper part of FIG. 3 there are shown some basic elements of standard call connection between two mobile phones on any mobile network. First element is the radio cellular connection between the phone and the nearest cell\base station of the mobile operator. The connection is then managed on the core service provider network onto the recipient base station where it is transmitted again over the radio cellular connection to the recipient mobile phone.

In the lower part of FIG. 3 there are shown the flow of a standard call connection adding the portable cyber security device attached to each mobile phone. In 321 we refer to the portable cyber security device attached to the mobile phone A is close range acquiring its radio cellular network. In 322 we refer to the cellular radio signal transmitted to a nearest base station from the portable cyber security device after it was encrypted. In 323 we refer to the traffic delivery in the service provider core network, the traffic may be of a standard method. In 324 we refer to the encrypted cellular radio signal transmitted from the base station to the portable cyber security device attached to mobile Phone B. In 325 we refer to the portable cyber security device getting the encrypted radio transmission, decrypt it and deliver it over a virtual cellular network to mobile phone B.

A portable cyber security device providing network protection for any mobile phone. The portable cyber security device is configured to make a secured voice and SMS packet encryption/decryption connection during mobile communication. The portable cyber security device is attached in close-range to the mobile phone, the mobile phone has no physical connection to the portable cyber security device.

The portable cyber security device has a virtual base station to establish close-range private cellular network with the mobile phone. The portable cyber security device has a processing unit with independent firewall and cyber security module to manage the routing\processing and encryption\decryption of the traffic. The portable cyber security device has a cellular modem or cellular module to manage the connection with the commercial cellular network. When the portable cyber security device is attached to the mobile phone, a security communication mode is activated and the communication between users can be prevented from being disclosed.

Portable battery powered base station. The portable cyber security device is a battery powered personal base station that may be running a low power circuit optimized for personal use of base station technology.

The low power optimization may be achieved by using a slim version of 3G/LTE software stack and lowering the RF transmitting power of the small cell chip in use by enhancing the hardware and software components.

Magnetic device protection. The portable cyber security device may be attached magnetically to the mobile/cellular devices.

In jacket cyber protection

The portable cyber security device may run in a battery powered jacket that fits to any mobile phone with no physical electronic connection to the mobile device itself.

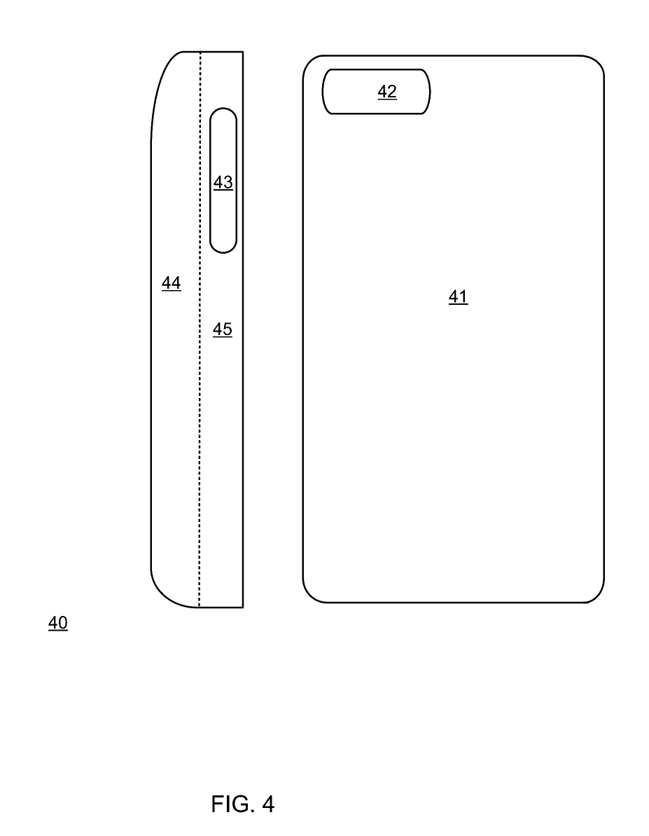

FIG. 4 illustrates a jacket 40 that includes the portable cyber security device according to an embodiment of the invention. Jacket 40 may be shaped to fit a mobile phone. It includes a back sidewall 41 with an aperture that is shaped and positioned such as not to conceal the camera of the mobile phone. The jacket 40 has a curved back portion 44 and a front portion 45. The mobile phone may be inserted in the front portion 45. The front portion may include a side aperture 43 for exposing buttons of the mobile phone.

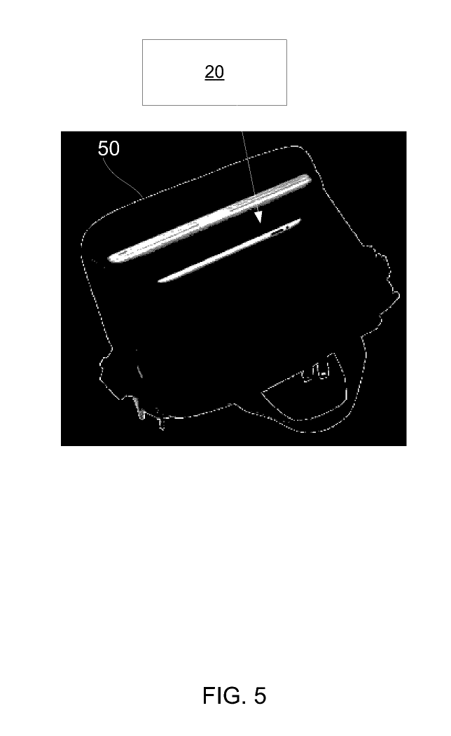

FIG. 5 illustrates a handbag 50 that includes the portable cyber security device 20 according to an embodiment of the invention.

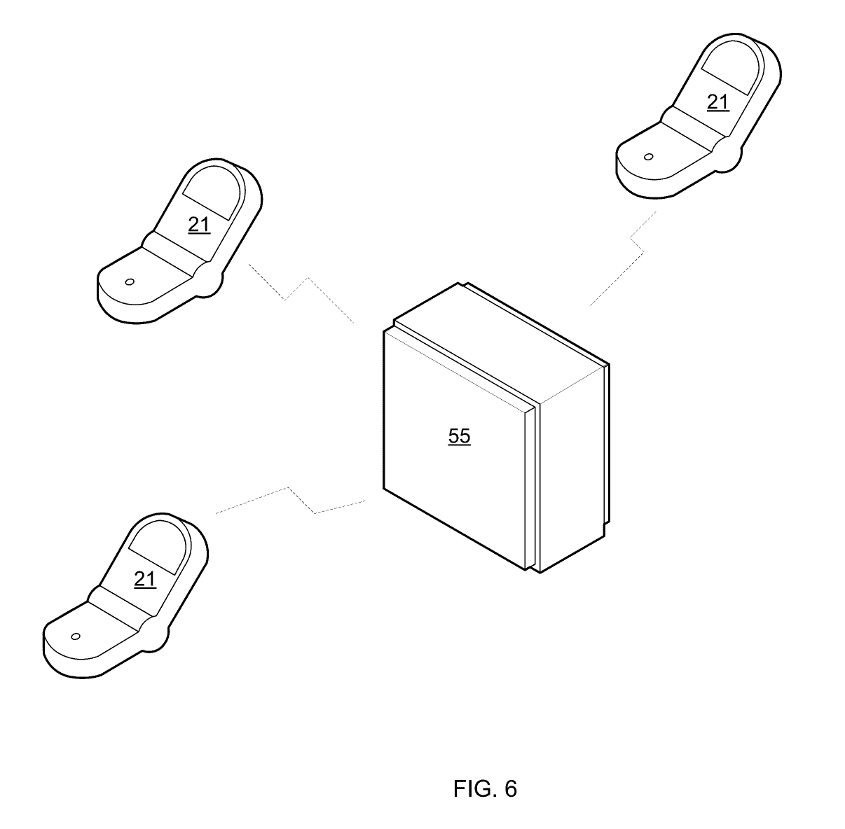

FIG. 6 illustrates a stand-alone portable cyber security device 55 and multiple mobile phones 21 according to an embodiment of the invention.

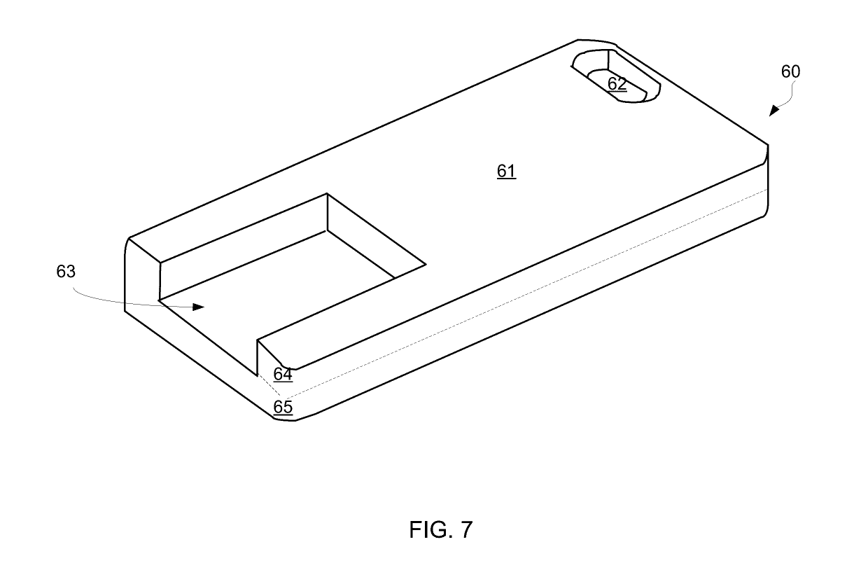

FIG. 7 illustrates a jacket 60 that is detachably connected to the portable cyber security device according to an embodiment of the invention. The jacket 60 may surround the mobile phone and may include a recess 63 in which the portable cyber security device may be inserted. The portable cyber security device may be connected to the jacket using any mechanical and/or magnetic detachment elements.

Jacket 60 also include an aperture 62 and aback wall. 61.

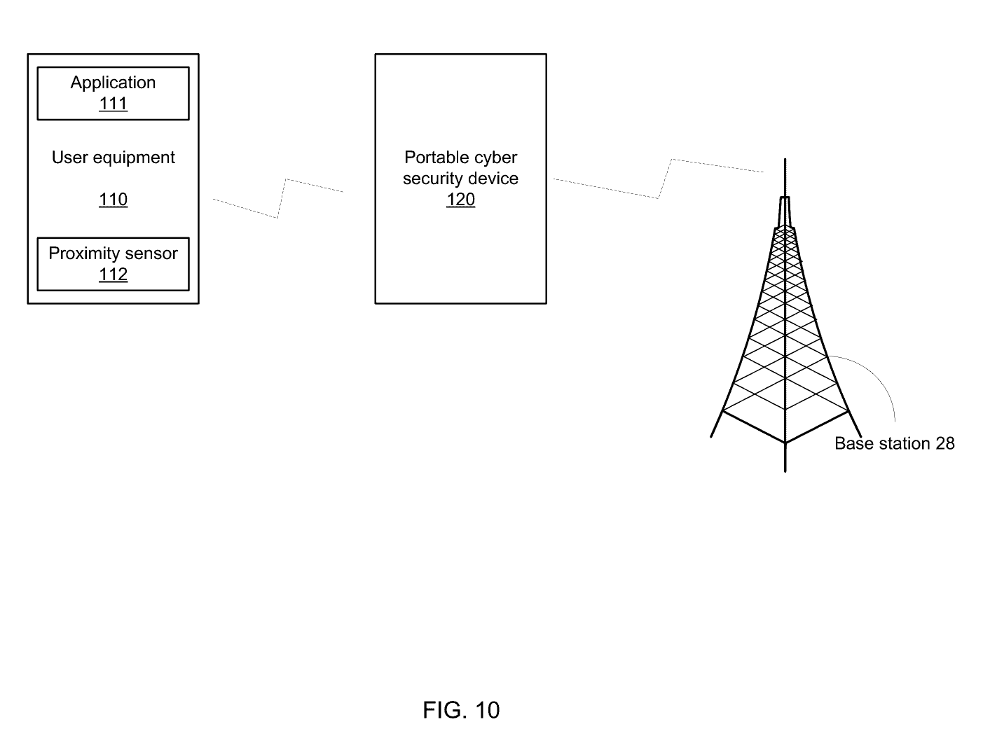

Proximity based protection. The portable cyber security device may activate and deactivate on proximity based on NFC and network detection of the portable cyber security device unique network connection to the mobile/cellular device. The mobile device may host an application or other type of software to identify the mobile phone is in proximity to the portable cyber security device (proximity—a predefined distance such a distance that may range between zero and 5 meters—or any other predefined distance). The application may enable/disable organizational application like mail and cloud access on proximity to the portable cyber security device. The organization software on the device may have a software component to communicate with that may notify=if the portable cyber security device is connected or not and by that may enable/disable the application capabilities accordingly. FIG. 10 illustrates a portable cyber security device 20 that communicates with base station 28 and with a user equipment (UE) such as but not limited a mobile phone. The user equipment 110 has a proximity sensor 112 for sensing when the portable cyber security device 120 is proximate to the user equipment 110 and the application 111 may control the operation of the user equipment 110 based on the proximity sensing. For example—not open emails or not open documents or otherwise enable the retrieval of information and/or the installation on software—unless the user equipment 110 is proximate to the user equipment 110.

Network tapping protection. The portable cyber security device may provide private network authentication. The cellular network authentication and key exchange based on the standard UMTS/LTE protocols is done between the portable cyber security device and cellular/mobile device inclusively. The portable cyber security device includes core cellular network elements to secure private connection between the user equipment 110 and devices attached to it. It means the keys are created on the user equipment 110 built in AuC authentication server and exchanged with the cellular MS device according to the standard protocols. When the mobile device is turned on, it sends authentication message with its IMSI to the cellular network. This message is sent to the portable cyber security device HLR/AuC authentication server network module (and not the commercial network one) that confirms the authentication and sends back to the mobile device acknowledge with the TMSI and confirmation to send and receive calls on the network. By doing that the protocols key exchange is not exposed on the operator cellular network and therefore protected from eavesdropping and potential man-in-the-middle attack to compromise the authentication process.

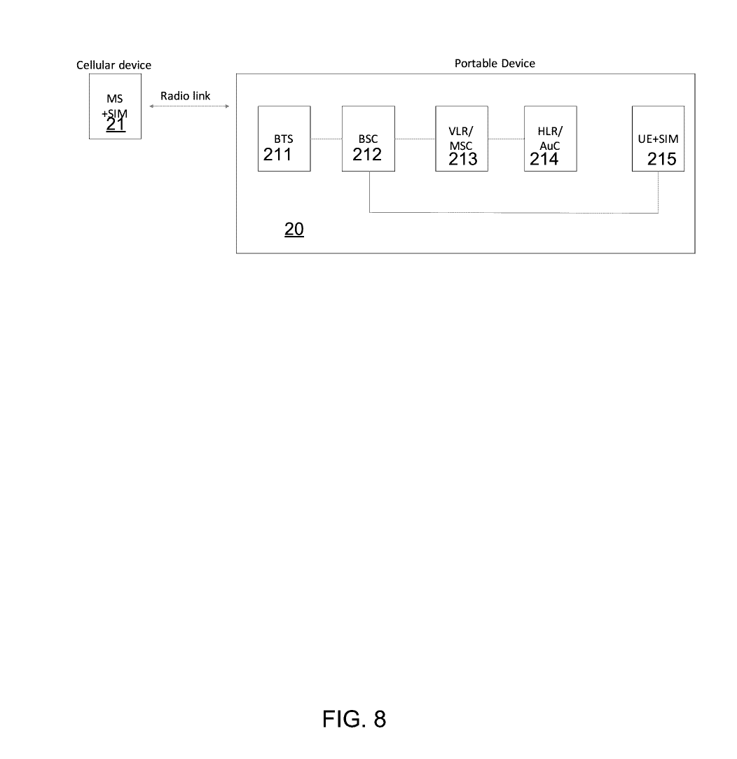

FIG. 8 illustrates the portable cyber security device 20 as including a BST 211, BSC 212, VLR/MSC 213, HLR/Auc 214 and UE+SIM 215.

BTS stands for base transceiver station. MSC stands for mobile switching center. BSC stands for base station controller. VLR stands for visitor location register. AuC stands for authentication center.

Encrypted standard calls and SMS. The portable cyber security device may scramble and encrypt the standard voice calls and SMS in near real time when a call is established between two portable cyber security devices. The encryption method is based on analog voice scrambling based on public key method to share the order of scrambling between the two parties. The voice analog scrambling algorithm is based on Frequency domain scrambling which is invert of the frequencies of the voice. The algorithm rules how to invert the frequencies with be based on digital encryption based on AES/DES encryption and key exchange methods. The encryption keys may be exchanged on the cellular data secured connection established between the portable cyber security devices.

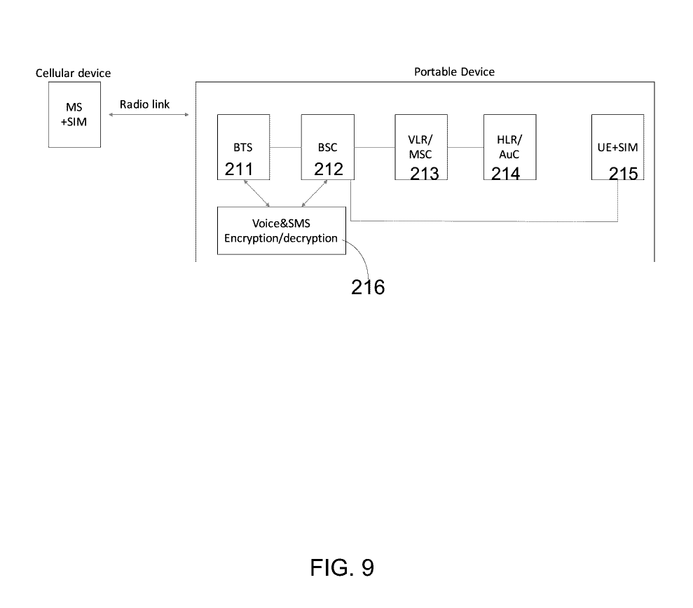

FIG. 9 illustrates the portable cyber security device 20 as including a BST 211, BSC 212, VLR/MSC 213, HLR/Auc 214, UE+SIM 215 and voice & SMS encryption/decryption module 216.

Next Gen portable firewall (NGFW) on portable cyber security device. The data channel of mobile/cellular device going through the portable cyber security device may be NATed and protected using next generation firewall. The NGFW include functions such as packet filtering, network- and port-address translation (NAT), stateful inspection, virtual private network (VPN) support, and improved filtering of network traffic that is dependent on the packet contents based on deep packet inspection technologies checking packet payloads and matching signatures for harmful activities such as exploitable attacks and malwares. Data leakage and zero-day protection.

The NGFW may protect the device from exploitable attacks and malwares coming from the cellular network but also may identify potential compromised mobile phone by identifying malwares command and control and data leakage suspected connections and notify about them to the management suite and organization.

Baseband firewall. The mobile device includes baseband firewall that protects from man-in-the-middle attacks on the cellular network. The Baseband firewall may block SS7 based attacks from reaching the mobile device and also identify fake base stations and cells and notify the management suite and organization.

Stealth mode and impersonalization. The portable cyber security device may provide stealth mode and impersonalization capabilities. It means that by connecting a mobile device to the portable cyber security device, the mobile device no longer appears on the commercial network. All communication is done through the portable cyber security device and the device identity on the network is the portable cyber security device's rather than the mobile device. By that and additional capabilities of software sim in the portable cyber security device we can change identity frequently and therefore maintain stealth mode for the mobile device. Impersonalization means that the mobile/cellular device is communicating with the network and other recipients while the connection identifiers like IMSI, IMEI and SIM info on the network is not his real one but the portable cyber security device and its SIM inside.

The portable cyber security device may work with any cellular device seamlessly. The mobile device imitates a standard cellular base station with the standard protocols. Therefore, any mobile/cellular device can connect to the portable cyber security device making it an agnostic security solution.

Enterprise security with no software installed on device. The portable cyber security device may include all organization data protection like VPN, authentication keys, cloud data access, mail access. And by maintaining all services running on the portable cyber security device we allow seamless and software free access to any allowed mobile/cellular device to the organization.

The portable cyber security device may have the following capabilities (perform cyber security operation of) NextGen Firewall, VPN, zero-day, data leakage NFV/SDN, baseband firewall.

The portable cyber security device may have a management system (for example hosted by processing unit 21) that may perform alerts provisioning licensing & policies keys enrollment firmware updates.

The virtual base station may be a close-range base station (Yoctocell)—3G/4. The processing unit may be a system on chip that includes multi-cores.

The cellular network module may include a UE Cellular modem—3G/4G.

The portable cyber security device may be powered by one or more built-in and/or detachable rechargeable battery. The memory may be a micro SD memory card slot.

The IO may be a USB charging and communication port.

The portable cyber security device may be VNF ready (Virtual Network Function).

The suggested device may provide the following benefits:

The portable cyber security device is a “zero-touch” mobile protection device attached to any the mobile phone. there is no need for any wiring.

The portable cyber security device can be matched to any phone on the market, it is not dependent on make or model or any third party software installed.

The portable cyber security device is easy to operate. The user only needs to attach the portable cyber security device on the mobile phone and follow simple operation steps without additional training. These simple operations steps are an option.

The portable cyber security device operation is transparent to mobile phone user, there is no need for any action besides attaching the portable cyber security device to the mobile phone

The user can achieve security communication that is not dependent on the Telecom operators to network infrastructure

The portable cyber security device may work on the native voice and SMS cellular network and is not dependent on the use of data channels

The portable cyber security device may work on the native voice channel, therefore preserves standard voice calls quality of service

The portable cyber security device can be easily disconnected from the mobile phone, simply detach the portable cyber security device from the mobile phone.

The portable cyber security device can serve one or many mobile phones at the same time.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It may , however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art may recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art may recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents may now occur to those of ordinary skill in the art. It is, therefore, to be understood that the appended claims are intended to cover all such modifications and changes as fall within the true spirit of the invention.

1. A portable cyber security device, comprising:
a virtual base station;
a cyber security processor; and
a cellular network module;
wherein the virtual base station is configured to communicate with a mobile phone;
wherein the cellular network module is configured to communicate with a base station of a cellular network; and
wherein the cyber security processor is configured to apply a cyber security operation on content received by either one of the virtual base station and the cellular network module.

2. The portable cyber security device according to claim 1 wherein the cyber security operation is a firewall operation; and wherein the cyber security processor is configured to apply the firewall operation on inbound communication received by the cellular network module and is targeted to the mobile device.

3. The portable cyber security device according to claim 1 wherein the cyber security operation is an encryption operation; and wherein the cyber security processor is configured to apply the encryption operation on an outbound communication received by the virtual base station and is targeted to the base station.

4. The portable cyber security device according to claim 1 comprising a magnet for magnetically coupling the portable cyber security device to the mobile phone.

5. The portable cyber security device according to claim 1 comprising a mechanical interface for mechanically coupling the portable cyber security device to the mobile phone.

6. The portable cyber security device according to claim 1 wherein the virtual base station has a reception range that has a length that does not exceed a meter.

7. The portable cyber security device according to claim 1 wherein the virtual base station has a reception range that has a length that does not exceed half a meter.

8. The portable cyber security device according to claim 1 wherein at least one of the cyber security processor and the virtual base station is configured to extract native voice from a native voice channel; and wherein the cyber security processor is configured to perform the cyber security operation on voice conveyed over the native voice channel.

9. The portable cyber security device according to claim 1 that is further configured to induce the mobile device to register the virtual base station as a base station of the mobile phone.

10. The portable cyber security device according to claim 1 that is further adapted to transmit to the mobile device information about a cyber security problem.

11. The portable cyber security device according to claim 1 that is further adapted to transmit to the mobile device information about a cyber security state of the mobile device.

12. The portable cyber security device according to claim 1 comprises a housing;
wherein the virtual base station, cyber security processor and the cellular network module are enclosed in the housing.

13. The portable cyber security device according to claim 1 wherein a thickness of the portable cyber security device does not exceed 4 millimeters.

14. The portable cyber security device according to claim 12 wherein a thickness of the portable cyber security device does not exceed 8 millimeters.

15. The portable cyber security device according to claim 1 comprising a proximity sensor for sensing that the mobile phone and the portable cyber security device are proximate to each other.

16. The portable cyber security device according to claim 1 wherein the cellular network module comprises an intensity sensor for sensing an intensity of transmissions from base stations of the cellular network and wherein the portable cyber security device is configured to determine an intensity of transmission to the mobile phone based on the intensity of transmissions from base stations of the cellular network.

17. The portable cyber security device according to claim 16 wherein the portable cyber security device is configured to determine the intensity of transmission to the mobile phone to exceed by a predefined margin from the intensity of transmissions from the base stations of the cellular network.

18. A method for providing cyber security by a portable cyber security device, the method comprising: communicating, by a virtual base station of the portable cyber security device with a mobile phone; communicating, by a cellular network module of the portable cyber security device with a base station of a cellular network; and applying by a cyber security processor of the portable cyber security device a cyber security operation on content received by either one of the virtual base station and the cellular network module.

19. comprising a proximity sensor for sensing that the mobile phone and the portable cyber security device are proximate to each other
